(19) United States
(12) Patent Application Publication
(10) Pub. No.: US 2007/0167312 A1
(43) Pub. Date: Jul. 19, 2007

(54) Process for manufacturing acid-containing bound zeolite particles

(75) Inventor: Joseph Rossin, Columbus, OH (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Guild Associates, Inc.

(21) Appl. No.: 11/334,853

(22) Filed: Jan. 19, 2006

(51) Int. Cl. C01B 39/00; B01J 29/06; B01J 29/04

(52) U.S. Cl. 502/64; 502/60; 423/700

(57) ABSTRACT

The invention provides processes for manufacturing bound zeolite beads, particles, rings, etc. wherein the bound zeolite contains moieties of sulfur, phosphorous, chlorine, bromine, fluorine and/or nitrate, and or organic acids.

### TECHNICAL FIELD

The present invention relates to processes for large-scale manufacturing of acid impregnated zeolite particles, beads, rings, etc. for the removal of basic environmental pollutants, including ethylene oxide, from streams of dry and humid air.

### BACKGROUND

Basic environmental pollutants, examples of which include ammonia, ethylene oxide (“EO”), propylene oxide (“PO”), monomethyl amine, dimethyl amine, and hydrazine, are highly toxic. The US Department of Labor Occupational Safety and Health Administration (“OSHA”) has set stringent guidelines aimed at protecting workers performing operations in an environment potentially contaminated with basic environmental pollutants. For example, the Permissible Exposure Limit (“PEL”) for EO has been established at 1.8 mg/m³ (approximately 1 ppm). As a result, effective, low cost means of manufacturing materials for the removal of basic environmental pollutants from ambient streams of air are needed.

Karwacki and Rossin (U.S. Pat. No. 6,837,917) report a process employing acidified, pentasil-based zeolites (e.g., H-ZSM-5) for the removal of basic environmental pollutants (e.g., EO and NH₃) from stream of dry and humid air. The material employed in the process disclosed by Karwacki and Rossin proved highly effective, especially when the zeolite material was further impregnated with organic acid or mineral acid. Impregnation of the zeolite particles with organic acids or sulfate compounds, such as for example citric acid and ammonium bisulfate, does not significantly affect the ethylene oxide filtration performance, but results in an increase in the ammonia filtration performance. Karwacki and Rossin did not provide a method for the large-scale manufacturing of the material.

The commercial-scale manufacture of zeolite beads, particles, rings, etc. is well known to one skilled in the art. Zeolite crystals are too small to be employed directly in filtration applications due to excessive pressure drop. Zeolite crystals must be formed into beads, particles, rings, etc., or alternatively, be coated onto a monolithic substrate. Zeolite crystals may be shaped into a variety of usable forms through the use of a binder material. Examples of binders include clays, plastics, aluminum oxides, zirconium oxides and silicon oxides, or mixtures thereof. Particles, rings, beads, etc. comprising zeolite crystals can be prepared by blending the zeolite crystals with the desired amount of the binder material. Once blended, the zeolite/binder material can be extruded into a variety of shapes, such as for example cylinders, using an extruder with the appropriate die. Alternatively, bound zeolite beads can be prepared by extruding small cylinders of the zeolite/binder formulation, then dropping the cylinders directly onto a spinning disc. Once formed, the shaped zeolite/binder material must be first dried in order to remove excess water (or solvent, should plastic binders be employed), then calcined at an elevated temperature, such as for example 500° C., in order to activate the binder. In the case of plastic binders, no calcinations step is necessary.

### SUMMARY

The present invention, according to one embodiment, comprises a process for impregnating zeolite shapes in general, and pentasil zeolite (e.g., ZSM-5) shapes in particular, with organic acids and/or compounds of sulfates, nitrates, chlorides, fluorides, phosphates and bromides. According to one embodiment, the present process employs beads of ZSM-5 bound together using a clay binder, with the ZSM-5 zeolite in the acidic form (“H-ZSM-5”). The impregnation process described herein is designed to associate the impregnant compounds with the binder material, rather than within the pores of the zeolite. This is because the pores of the zeolite are approximately the size of small molecules, and incorporation of excessive impregnant into the pores of the zeolite may impact intrazeolitic mass transfer, especially for basic chemicals that are removed via catalyzed hydrolysis reaction such as, for example, ethylene oxide.

The impregnation process described herein may employ a metal salt, a mineral acid, an amine salt, or an organic acid, or mixtures thereof. The method of impregnation may differ with the class of impregnants as described above. For example, the impregnation processes according to an embodiment of the invention employing metal salts may be performed by dry-mixing the metal salt and the bound zeolite bead. Impregnation processes according to an embodiment of the invention involving mineral acids may be performed via incipient wetness techniques. Impregnation processes according to an embodiment of the invention involving amine salts may be performed via incipient wetness techniques, which may be followed by calcinations at a temperature sufficient to decompose the amine. Impregnation techniques involving organic acids may be performed by dry mixing or incipient wetness.

### DETAILED DESCRIPTION OF EMBODIMENTS

Impregnation processes described herein may employ a metal salt, a mineral acid, an amine salt, or an organic acid, and/or mixtures thereof. Examples of metal salts include, but are not limited to, copper chloride, copper sulfate, copper phosphate, nickel chloride, nickel chloride, nickel nitrate, zinc chloride, zinc nitrate, and/or zinc sulfate. Examples of mineral acids may include sulfuric acid, nitric acid, hydrofluoric acid, hydrochloric acid and/or phosphoric acid. Examples of amine salts may include ammonium chloride, ammonium hydroxide, ammonium nitrate, ammonium bisulfate, ammonium phosphate, and/or monomethyl ammonium chloride. Examples of organic acids may include citric acid, formic acid and/or propane acid.

Additional organohalogen compounds (e.g., chlorine-substituted benzenes), organophosphate compounds (e.g., dimethyl methyl phosphate), and organosulfate compounds (e.g., carbonyl sulfate) may be employed in the impregnation; however, these compounds may be less efficient at acidifying the binder.

Impregnation with Metal Salts: When impregnating bound zeolite with metal salts according to one embodiment of the invention, dry mixing of the beads with small particles of the metal salt may be preferred. In this manner, small metals salt crystals may become associated with the zeolite binder via physical means. The metal salts become associated with the binder, rather than within the pores of the zeolite, because the metal salt particles are too large to enter the pores of the zeolite. Attempts to associate the metal salt using wet techniques such as impregnation fail because it is believed the metal salt will enter the pores of the zeolite, rendering the bound zeolite ineffective for filtration of basic chemicals that are removed by acid catalyzed hydrolysis reactions that occur within the pores of the zeolite such as, for example, ethylene oxide and propylene oxide.

Techniques for dry-mixing bound zeolite with metal salts involve placing the desired quantities of bound zeolite and metal salt in an apparatus designed to bring about the physical contact of the bound zeolite and the metal salt. Examples of equipment may include drum mixers, tumblers, V-blenders, rotary mixers, etc. The duration of the dry mixing and the temperature of the dry mixing may vary based on the desired metal salt content of the bound zeolite and the nature of the metal salt employed. The duration of the dry mixing operation may vary between about 15 minutes and in excess of 1 week; however, attempts should be made to minimize the dry mixing time, as increased dry-mixing time will result in attrition of the bound zeolite. A preferred dry mixing time may be between about 15 minutes and 24 hours, with a more preferred dry mixing time between about 3 hours and about 6 hours. A small amount of water may be added to the metal salt, such as an amount necessary to form a paste-like substance, if desired, in order to decrease the duration of the dry mixing operation. Although not necessary, following dry mixing, it may be desired that the metal salt impregnated bound zeolite be further processed to remove fines (i.e., particles less than the desired size, such as for example, particles of attrition). Techniques may include, but not be limited to, sieving or blowing the product metal salt impregnated bound zeolite.

Impregnation with Mineral Acids: When impregnating bound zeolite with mineral acids, wet impregnation techniques, followed by drying and an optional calcinations step, the preferred manufacturing route. When impregnating bound zeolite with mineral acids, it is preferred that the binder be an inorganic metal oxide such as, for example, oxides of zirconium, silicon or aluminum, or mixtures thereof. Plastics are not preferred because plastics typically do not offer sites suitable for acidification.

Impregnation techniques involve contacting bound zeolite with solutions of mineral acids necessary to achieve the desired mineral acid loading such as, for example, about 0.1% and about 10% by weight, and preferably about 1% and about 5% by weight. Techniques for contacting bound zeolite with mineral acid solutions may include impregnation to incipient wetness, dipping the bound zeolite into a vat of solution containing the desired mineral acid(s), or spraying the bound zeolite with a solution containing the desired mineral acid(s). Following impregnation, the bound zeolite may be dried to remove any excess moisture. Techniques for drying the mineral acid impregnated bound zeolite include, but are not limited to, rotary drying, batch drying, or forced air drying. For example, a batch drying operation may involve placing the mineral acid impregnated bound zeolite into pans, then placing the pans into a forced convection oven at temperatures between about 20° C. and about 250° C., with a preferred temperature between about 80° C. and about 150° C. In another example, the mineral acid impregnated bound zeolite may be placed in a rotary drier at the desired temperature as specified above for a duration necessary to achieve the desired level of dryness. In still another example, mineral acid impregnated bound zeolite may be placed on trays and dried by exposing to hot flue gas until the desired moisture content is achieved. The drying operation is complete when the moisture content of the product is at or below the desired level such as, for example, less than about 20% moisture, more preferably less than about 10% moisture, and even more preferably less than about 5% moisture by weight.

Mineral acids are highly reactive. During impregnation, the mineral acids may first interact with sites associated with the inorganic metal oxide binder, rather than with sites present with the zeolite. This may be because the larger pores associated with the binder result in the binder material being more accessible to the impregnation solution than the zeolite. It is only when sites associated with the inorganic binder become consumed that the mineral acid will begin to interact with sites located within the zeolite. Location of mineral acids, such as for example sulfuric, within the zeolite, will restrict mass transfer.

As an option, the zeolite may be calcined following drying at temperatures between greater than about 250° C. to about 750° C., and preferably between about 450° C. and about 550° C. Calcination will remove weakly bonded acid, thereby minimizing leaching of acid from the product bound zeolite during prolonged operation under conditions of high relative humidity. Leaching of acid may result in excessive corrosion of construction material associated with the filtration apparatus. Calcination may be performed by placing the mineral acid impregnated bound zeolite within a device capable of achieving the desired calcinations temperature, such as, for example, a furnace or rotary calciner.

Impregnation with Amine Salts: When impregnating bound zeolite with amine salts, wet impregnation techniques, followed by a drying and a calcination step, may be preferred. When impregnating bound zeolite with amine salts, it may be preferred that the binder be an inorganic metal oxide such as, for example, oxides of zirconium, silicon or aluminum, and/or mixtures thereof. Plastics are not preferred because plastics typically do not offer sites suitable for acidification.

Impregnation techniques may involve contacting bound zeolite with solutions of amine salts necessary to achieve the desired loading such as, for example, between about 0.1% and about 10% by weight chloride, fluoride, bromide or sulfate, and preferably between about 1% and about 5% by weight chloride, fluoride, bromide or sulfate, and/or mixtures thereof. Techniques for contacting bound zeolite with amine salt solutions include impregnation to incipient wetness, dipping the bound zeolite into a vat of solution containing the desired amine salt, or spraying the bound zeolite with a solution containing the desired amine salt. Following impregnation, the bound zeolite must be dried to remove the excess moisture. Techniques for drying the mineral acid impregnated bound zeolite include, but are not limited to, rotary drying, batch drying, or forced air drying. For example, a batch drying operation may involve placing the mineral acid impregnated bound zeolite into pans, then placing the pans into a forced convection oven at temperatures of about 20° C. to about 250° C., with a preferred temperature of about 80° C. to about 150° C. In another example, the mineral acid impregnated bound zeolite may be placed in a rotary drier at the desired temperature as specified above for a duration necessary to achieve the desired level of dryness. In still another example, mineral acid impregnated bound zeolite may be placed on trays and dried by exposure to hot flue gas until the desired moisture content is achieved. The drying operation is complete when the moisture content of the product is at or below the desired level such as, for example, less than about 20% moisture, more preferably less than about 10% moisture, and even more preferably less than about 5% moisture by weight.

Alternatively, the amine salt may be impregnated using dry mixing techniques such as, for example, placing the desired quantities of bound zeolite and amine salt in an apparatus designed to bring about the physical contact of the bound zeolite and the amine salt. Examples of equipment may include drum mixers, tumblers, V-blenders, rotary mixers, etc. The duration of the dry mixing and the temperature of the dry mixing may vary based on the desired metal salt content of the bound zeolite and the nature of the metal salt employed. The duration of the dry mixing operation may vary between about 15 minutes and in excess of about 1 week; however, attempts may be made to minimize the dry mixing time, as increased dry-mixing time may result in attrition of the bound zeolite. A preferred dry mixing time is between about 15 minutes and about 24 hours, with a more preferred dry mixing time of about 3 hours to about 6 hours. A small amount of water may be added to the amine salt, such as an amount necessary to form a paste-like substance, if desired, in order to decrease the duration of the dry mixing operation. Although not necessary, following dry mixing, may be desired that the product amine salt impregnated bound zeolite be further processed to remove fines (i.e., particles less than the desired size, such as for example particles of attrition). Techniques may include, but not be limited to, sieving or blowing the product metal salt impregnated bound zeolite.

In order to activate, the amine salt impregnated bound zeolite may be calcined following drying or following dry mixing at temperatures ranging from about 250° C. to about 750° C., and preferably ranging from about 450° C. to about 550° C. Calcination may decompose the amine salt, leaving behind the fluorine, chlorine, bromine or sulfate component preferentially bound to the binder material, rather than within the pores of the zeolite. Calcination may be performed by placing the mineral acid impregnated bound zeolite within a device capable of achieving the desired calcination temperature, such as for example, a furnace or rotary calciner.

Impregnation with Organic Acids: When impregnating bound zeolite with organic acids, wet impregnation techniques, followed by drying and an optional calcination step, may be preferred. The binder may be either an inorganic metal oxide or plastic. Examples of inorganic metal oxides may include oxides of zirconium, silicon or aluminum, and/or mixtures thereof. Examples of plastic binder materials may include polyvinyl acetate and polyvinylpyrrolidone.

Impregnation techniques involve contacting bound zeolite with solutions of organic acids necessary to achieve the desired organic acid loading such as, for example, ranging from about 0.1% to about 10%, and preferably ranging from about 1% to about 5% by weight. Techniques for contacting bound zeolite wth organic acid solutions may include impregnation to incipient wetness, dipping the bound zeolite into a vat of solution containing the desired mineral acid(s), and/or spraying the bound zeolite with a solution containing the desired mineral acid(s).

Following impregnation, the bound zeolite may be dried to remove the excess moisture. Techniques for drying the mineral acid impregnated bound zeolite include, but are not limited to, rotary drying, batch drying, and/or forced air drying. For example, a batch drying operation may involve placing the organic acid impregnated bound zeolite into pans, then placing the pans into a forced convection oven at temperatures ranging from about 20° C. to about 250° C., with a preferred temperature ranging from about 80° C. to about 110° C. In another example, the organic acid impregnated bound zeolite may be placed in a rotary drier at the desired temperature as specified above for a duration necessary to achieve the desired level of dryness. In still another example, organic acid impregnated bound zeolite may be placed on trays and dried by exposing to hot flue gas until the desired moisture content is achieved. The drying operation is complete when the moisture content of the product is at or below the desired level, such as for example, less than about 20% moisture, more preferably less than about 10% moisture, and even more preferably less than about 5% moisture by weight.

Alternatively, the organic acid may be impregnated using dry mixing techniques provided the organic acid is a solid at the impregnation temperature. Dry mixing techniques may involve placing the desired quantities of bound zeolite and organic acid in an apparatus designed to bring about the physical contact of the bound zeolite and the organic acid. Examples of suitable equipment may include drum mixers, tumblers, V-blenders, rotary mixers, etc. The duration of the dry mixing and the temperature of the dry mixing may vary based on the desired organic content of the bound zeolite and the nature of the organic acid employed. The duration of the dry mixing operation can vary between about 15 minutes and in excess of about 1 week; however, attempts may be made to minimize the dry mixing time, as increased dry-mixing time will result in attrition of the bound zeolite. A preferred dry mixing time ranges from about 15 minutes to about 24 hours, with a more preferred dry mixing time ranging from about 3 hours to about 6 hours. A small amount of water may be added to the organic acid, such as an amount necessary to form a paste-like substance, if desired, in order to decrease the duration of the dry mixing operation. Although not necessary, following dry mixing, the product organic acid impregnated bound zeolite may be further processed to remove fines (i.e., particles less than the desired size, such as for example particles of attrition). Techniques may include, but not be limited to, sieving or blowing the product metal salt impregnated bound zeolite.

Testing: Impregnated, bound zeolite product was evaluated for its ability to purify air streams contaminated with ethylene oxide and ammonia. Ethylene oxide (EO) testing was performed by first pre-humidifying impregnated bound zeolite. Pre-humidification was performed by placing the impregnated bound zeolite product in an environmental chamber at 27° C., 80% RH (relative humidity), for a minimum of about 12 hours. Ethylene oxide testing was performed by placing approximately 26.4 c m³ impregnated bound zeolite in a 4.1 cm diameter adsorption tube. The resulting bed depth was 2.0 cm. Humid air (80% RH) contaminated with 1,000 mg/ m³ EO was delivered to the resulting adsorption bed at a flow rate of approximately 7.6l/min at 25° C. The flow rate corresponds to a linear velocity of 9.6 cm/s. The concentration of EO in the effluent stream was monitored using a gas chromatograph equipped with a flame ionization detector. The breakthrough concentration of EO is 1.8 mg/ m³. Under humid test conditions described above, EO will undergo a catalyzed hydrolysis reaction with acid sites located within the pores of the zeolite. Under humid test conditions as described above, EO will not undergo significant reaction with impregnants described herein. Therefore, testing with EO provides a means of probing the integrity of the acidified zeolite associated with the impregnated bound zeolite.

Ammonia (NH₃) testing was performed under both dry and humid test conditions. When testing under humid test conditions, the impregnated bound zeolite was pre-humidified prior to testing. Pre-humidification was performed by placing the impregnated bound zeolite product in an environmental chamber at 27° C., 80% RH, for a minimum of 12 hours. As-prepared material was employed when performing tests under 15% RH test conditions. Ammonia testing was performed by placing approximately 15.1 cm³ impregnated bound zeolite in a 3.1 cm diameter adsorption tube. The resulting bed depth was 2.0 cm. Humid (80% RH) or dry (15% RH) contaminated with 1,000 mg/ M³ NH₃ was delivered to the resulting adsorption bed at a flow rate of approximately 4.35 l/min at 25° C. The flow rate corresponds to a linear velocity of 9.6 cm/s. The concentration of NH₃ in the effluent stream was monitored using a UV spectrometer. The breakthrough concentration of NH₃ is 35 mg/M³. Under dry test conditions, NH₃ is removed via reactions between the impregnants and the acid sites located within the zeolite. Under humid test conditions, ammonia is removed primarily by reactions involving the impregnants. Therefore, testing with ammonia provides a means of probing the integrity of the impregnant associated with the impregnated bound zeolite.

### EXAMPLE 1 (COMPARATIVE)

### Performance of Un-impregnated Bound Zeolite

12×30 mesh bound zeolite beads (H-ZSM-5) were evaluated for their ability to purify streams of air contaminated with EO and NH₃. The binder was comprised of mixed inorganic metal oxides and comprised approximately 25% of the weight of the beads.

| | Relative | Breakthrough |
|---|---|---|
| Chemical | Humidity | Time |
| Ethylene Oxide | 80% | >60 minutes |
| NH₃ | 80% | 27 minutes |
| NH₃ | 15% | 40 minutes |

### EXAMPLE 2 (COMPARATIVE)

### Preparation Involving Wet Impregnation of Metal Salt

25 kg of acidified 12×30 mesh bound zeolite beads (H-ZSM-5) were dried to less than 5% water by weight in a forced convection oven at about 110° C. The binder was comprised of mixed inorganic metal oxides and comprised approximately 25% of the weight of the beads. A copper sulfate pentahydrate (CuSO₄•5H₂O) solution was prepared by dissolving 1.175 kg of copper sulfate pentahydrate (63.5% by weight copper sulfate) in 17.5 liters of deionized water. The bound zeolite beads were impregnated to incipient wetness using the entire 17.5 liters of solution. Following impregnation, the material was divided onto shallow pans and placed within a forced convection oven at 110° C. for 6 hours in order to dry the material to less than 5% water by weight. Following drying, product material was evaluated for its ability to purify air streams contaminated with EO and NH₃. EO and NH₃ breakthrough times are reported below:

| | Relative | Breakthrough |
|---|---|---|
| Chemical | Humidity | Time |
| Ethylene Oxide | 80% | 4 minutes |
| NH₃ | 80% | 35 minutes |
| NH₃ | 15% | 46 minutes |

Results demonstrate the wet impregnation technique significantly decreases the ability of the product impregnated bound zeolite to filter EO from streams of humid air.

### EXAMPLE 3

### Preparation Involving Dry Mixing of Metal Salt

25 kg of acidified 12×30 mesh bound zeolite beads (H-ZSM-5) were placed in a drum mixer. The binder was comprised of mixed inorganic metal oxides and comprised approximately 25% of the weight of the beads. To the drum mixer was added 1.175 kg of copper sulfate pentahydrate (CuSO₄•5H₂O). The drum mixer was sealed and rotated for 4 hours at room temperature. Following 4 hours, the resulting material was removed from the drum. Once removed, product material was sieved to remove the below 30 mesh fraction. Approximately 25.3 kg of product material was recovered. Product material was evaluated for its ability to purify air streams contaminated with EO and NH₃. EO and NH₃ breakthrough times are reported below:

| | Relative | Breakthrough |
|---|---|---|
| Chemical | Humidity | Time |
| Ethylene Oxide | 80% | >60 minutes |
| NH₃ | 80% | 48 minutes |
| NH₃ | 15% | 61 minutes |

Results demonstrate the ability of the dry mixing impregnation technique to enhances the ability of the product impregnated bound zeolite to purify air contaminated with ammonia while maintaining a greater than 60 minute EO breakthrough time.

### EXAMPLE 4

### Preparation Involving Wet Impregnation of Mineral Acid

25 kg of acidified 12×30 mesh bound zeolite beads (H-ZSM-5) were dried to less than 5% water by weight in a forced convection oven at 110° C. The binder was comprised of mixed inorganic metal oxides and comprised approximately 25% of the weight of the beads. An impregnation solution was prepared by adding 0.75 kg of reagent grade sulfuric acid (H2SO₄) to 17.5 liters of deionized water. The bound zeolite beads were impregnated to incipient wetness using the entire 17.5 liters of solution. Following impregnation, the material was divided onto shallow pans and placed within a forced convection oven at 110° C. for 6 hours in order to dry the material to less than 5% water by weight. Product material was evaluated for its ability to purify air streams contaminated with EO and NH₃. EO and NH₃ breakthrough times are reported below:

| | Relative | Breakthrough |
|---|---|---|
| Chemical | Humidity | Time |
| Ethylene Oxide | 80% | >60 minutes |
| NH₃ | 80% | 45 minutes |
| NH₃ | 15% | 54 minutes |

A portion of the dried, sulfate impregnated bound zeolite beads were further calcined at 450° C. for 3 hours in a forced convection oven. Product material was evaluated for its ability to purify air streams contaminated with EO and NH₃. EO and NH₃ breakthrough times are reported below:

| | Relative | Breakthrough |
|---|---|---|
| Chemical | Humidity | Time |
| Ethylene Oxide | 80% | >60 minutes |
| NH₃ | 80% | 43 minutes |
| NH₃ | 15% | 53 minutes |

Results demonstrate the ability of the wet impregnation technique to enhances the ability of the product impregnated bound zeolite to purify air contaminated with ammonia while maintaining a greater than 60 minute EO breakthrough time.

A 1 g of product 12×30 mesh impregnated bound zeolite dried at 110° C. was washed with 50 ml of DI water. The pH of the wash water was 2.38. A 1 g of product 12×30 mesh impregnated bound zeolite dried at 110° C. and further calcined at 450° C. was washed with 50 ml of DI water. The pH of the wash water was 4.36. Result indicates that calcinations of the product material decreases the ability of the resulting material to leach sulfate.

### EXAMPLE 5

### Preparation Involving Wet Impregnation of Amine Salt

25 kg of acidified 12×30 mesh bound zeolite beads (H-ZSM-5) were dried to less than 5% water by weight in a forced convection oven at 110° C. The binder was comprised of mixed inorganic metal oxides and comprised approximately 25% of the weight of the beads. An impregnation solution was prepared by dissolving 1.01 kg of reagent grade ammonium bisulfate ((NH₄)₂SO₄) to 17.5 liters of deionized water. The bound zeolite beads were impregnated to incipient wetness using the entire 17.5 liters of solution. Following impregnation, the material was divided onto shallow pans and placed within a forced convection oven at 110° C. for 6 hours in order to dry the material to less than 5% water by weight. Following drying, the impregnated, bound zeolite beads were calcined at 550° C. for 3 hours in order to decompose the ammonium salt. Product material was evaluated for its ability to purify air streams contaminated with EO and NH₃. EO and NH₃ breakthrough times are reported below:

| | Relative | Breakthrough |
|---|---|---|
| Chemical | Humidity | Time |
| Ethylene Oxide | 80% | >60 minutes |
| NH₃ | 80% | 58 minutes |
| NH₃ | 15% | 58 minutes |

Results demonstrate the ability of the wet impregnation of amine salt technique to enhances the ability of the product impregnated bound zeolite to purify air contaminated with ammonia while maintaining a greater than 60 minute EO breakthrough time.

### EXAMPLE 6

### Preparation Involving Wet Impregnation of Organic Acid

25 kg of acidified 12×30 mesh bound zeolite beads (H-ZSM-5) were dried to less than 5% water by weight in a forced convection oven at 110° C. The binder was comprised of mixed inorganic metal oxides and comprised approximately 25% of the weight of the beads. An impregnation solution was prepared by dissolving 0.75 kg of citric acid (HOC(COOH)CH₂COOH)₂) to 17.5 liters of deionized water. The bound zeolite beads were impregnated to incipient wetness using the entire 17.5 liters of solution. Following impregnation, the material was divided onto shallow pans and placed within a forced convection oven at 110° C. for 6 hours in order to dry the material to less than 5% water by weight. Product material was evaluated for its ability to purify air streams contaminated with EO and NH₃. EO and NH₃ breakthrough times are reported below:

| | Relative | Breakthrough |
|---|---|---|
| Chemical | Humidity | Time |
| Ethylene Oxide | 80% | >60 minutes |
| NH₃ | 80% | 46 minutes |
| NH₃ | 15% | 53 minutes |

Results demonstrate the ability of the wet impregnation technique of organic acid to enhance the ability of the product impregnated bound zeolite to purify air contaminated with ammonia while maintaining a greater than 60 minute EO breakthrough time.

What is claimed is:

1. A process for impregnation of bound zeolite particles, said process comprising:
contacting the particles with dry metal salts in a contacting device.

2. A process according to claim 1, wherein a small amount of water is added to the metal salt before contact with the particles.

3. A process according to claim 1, wherein the metal salt is selected from the group of salts consisting of sulfates, chlorides, fluorides, bromides, nitrates, and mixtures thereof.

4. A process according to claim 1, wherein the metal component of the metal salts is selected from the group of metals consisting of chromium, iron, cobalt, nickel, copper, zinc, and mixtures thereof.

5. A process according to claim 1, wherein the contacted particles are further treated at temperatures up to 750° C.

6. A process for the impregnation of bound zeolite particles, said process comprising:
contacting the particles with a mineral acid solution in a contacting device, and drying the contacted particles to remove moisture.

7. A process according to claim 6, further comprising calcining the dried contacted particles at temperatures up to 750° C.

8. A process according to claim 6, wherein the mineral acid is selected from the group of acids consisting of sulfuric acid, hydrochloric acid, hydrofluoric acid or phosphoric acid, and mixtures thereof.

9. A process according to claim 7, wherein solution comprises amine salts.

10. A process according to claim 9, wherein the amine salt is selected from the group consisting of ammonium chloride, ammonium bisulfate, ammonium fluoride, ammonium hydroxide, ammonium nitrate, ammonium chloride, ammonium bromide, ammonium phosphate, monomethyl ammonium chloride, and mixtures thereof.

11. A process according to claim 10, wherein the amine salt contains sulfur.

12. A process for impregnation of bound zeolite particles, said process comprising:
contacting the parties with amine salts.

13. A process according to claim 12, wherein the particles are contacted and calcined for a period of time ranging from about 1 hour to about 24 hours.

14. A process according to claim 12, wherein a small amount of water is added to the amine salt prior to contact with the particles.

15. A process according to claim 12, wherein the amine salt is selected from the group of salts consisting of ammonium chloride, ammonium bisulfate, ammonium fluoride, ammonium hydroxide, ammonium nitrate, ammonium chloride, ammonium bromide, ammonium phosphate, monomethyl ammonium chloride, and mixtures thereof.

16. A process according to claim 12, wherein the contacted particles are further treated at temperatures up to 750° C.

17. A process for the impregnation of bound zeolite particles, said process comprising:
contacting the particles with an organic acid in a contacting device.

18. A process according to claim 17, wherein the organic acid is selected from the group of acids consisting of citric acid, propanoic acid, formic acid, and mixtures thereof.

19. The process according to claim 17, wherein the organic acid is in solution and further comprising drying the contacted particles to a desired level of moisture.

20. A process according to claim 17, wherein the organic acid is a dry organic acid.

21. A process according to claim 19, wherein the organic acid is selected from the group of acids consisting of citric acid, propanoic acid, formic acid, and mixtures thereof.
